(19) United States
(12) Patent Application Publication
(10) Pub. No.: US 2013/0271600 A1
(43) Pub. Date: Oct. 17, 2013

(54) SURVEILLANCE device with display and light-emitting modules

(71) Applicant: G-STAR INTERNATIONAL TELECOMMUNICATION CO., LTD, Taipei City (TW)

(72) Inventor: Min-Chieh Hsu, Taipei City (TW)

(73) Assignee: G-STAR International Telecommunication Co., LTD, Taipei City (TW)

(21) Appl. No.: 13/762,366

(22) Filed: Feb. 8, 2013

(30) Foreign Application Priority Data
Apr. 12, 2012 (TW) 101206637

(51) Int. Cl. H04N 7/18

(52) U.S. Cl. CPC H04N 7/183
USPC 348/143

(57) ABSTRACT

A surveillance device with display and light-emitting, is a photographic apparatus including a cover body, a display module and a plurality of light-emitting modules, wherein the cover body covers a photographic unit and there are the display module and the plurality of light-emitting modules set around the cover body, which power is provided by a power supply module. The text message shown by the display module and the flashing light of the light-emitting modules, both increase the highlighting effect of the photographic apparatus and become malfunction indications.

### BACKGROUND OF THE INVENTION

1. Field of the Invention

This invention is related to a surveillance device with a display and light-emitting modules, and more particular to a photographic device with a message display module and an obvious module.

2. Description of Related Art

The well known traditional surveillance camera device has the function of image recording, which is used as a remote monitor to replace the guards. Its application fields include: banks, airports, shopping malls and flat streets, so that the images and time of each event can be clearly recorded.

The surveillance camera device includes: a photographic device module, a shield and a power supply module, wherein the shield is used to protect the photographic device module so as to avoid impact from exposure to the external environment.

For example, moisture and pollutants in the environment would cause the lens and the internal circuit of the photographic device module broke, resulting in that the lifespan of the surveillance camera device is rapidly shortened. Therefore, the shield (used to protect the photographic device module) is an important component to isolate the surveillance camera device from the moisture and pollutants.

However, since the surveillance camera device is usually fixed at a high position, which is difficult to generate warning effect to someone having a potential intent to commit an illegal act.

In addition, there is no way to tell the surveillance device is out of the order from its appearance, when the surveillance photographic device is failed. The reason for such a failure needs to be manually processed by using detection equipment. Therefore the failure detection for the surveillance camera device is extremely inconvenient.

Therefore, how to improve the appearance of the surveillance camera device to achieve the purpose of deterrence and rapid detection is the main point the industry needs to improve urgently.

### SUMMARY OF THE INVENTION

The objective of this invention is to provide a surveillance device with a display and light-emitting module so as to achieve the highlighting effect and a message displaying.

In order to achieve above objective, the technical means of the present invention includes: a cover body having an accommodating space, a display module located on the cover body, and a plurality of light-emitting modules set on the cover body.

A power supply module provides current to the display module and the light-emitting modules. Thereby, the display module used to generate a text message and the light-emitting modules achieve the objective of the present invention via full light and flashing.

### BRIEF DESCRIPTION OF THE DRAWINGS

The invention, as well as its many advantages, may be further understood by the following detailed description and drawings in which:

FIG. 1 is a schematic diagram showing the surveillance device with a display module and light-emitting modules of the first embodiment of the present invention; and

FIG. 2 is a schematic diagram showing the surveillance device with a display module and light-emitting modules of the second embodiment of the present invention.

### DETAILED DESCRIPTION OF THE INVENTION

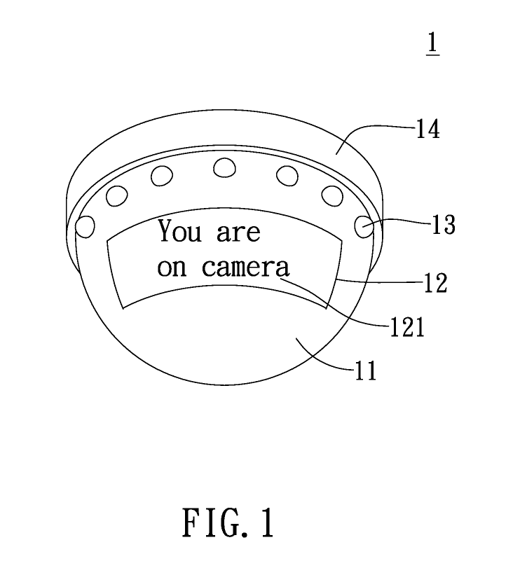

With reference to FIG. 1, which is the surveillance device with display and light-emitting of the first embodiment provided by the present invention, the surveillance device is used in, for example, a spherical, photographic device 1, including: a cover body 11, a display module 12, a plurality of light-emitting module 13 and a mount stand 14.

The cover body 11 is a hemispherical transparent body, having an accommodating space therein for covering a photographic unit (not shown in the figure), and the hemispherical transparent body having a cross section to be joined to one side of the mount stand 14. The display module 12 is located on the cover body 11, and has a display surface 121 exposed on the outer ring surface of the cover body 11. The light-emitting modules 13 are located around the ring surface of the cover body 11, and the light-emitting part of the light-emitting modules 13 faces toward the outer ring surface of the cover body 11.

While in use, the power supply module (not shown in the figure) of the spherical photographic device 1 provides current to the display module 12 and the light-emitting modules 13 respectively, so each one of them can operate individually. The types of the display module 12 are divided into a liquid crystal display (LCD), a light-emitting diode (LED) display or an organic light-emitting diode (OLED) display. Alarming function can be reached via the text messages generated by display surface 121. The light-emitting modules 13 located on the cover body 11 can reach highlighting purpose via full light or flashing.

Furthermore, the text messages input from an external input module (not shown in the figure) are wirelessly transmitted to the display module 12 for display. Or the spherical photographic device 1 has a memory circuit substrate (not shown in the figure) to store the text messages in advance and to electrically connect to the display module 12, so that the display module 12 is able to display the text messages.

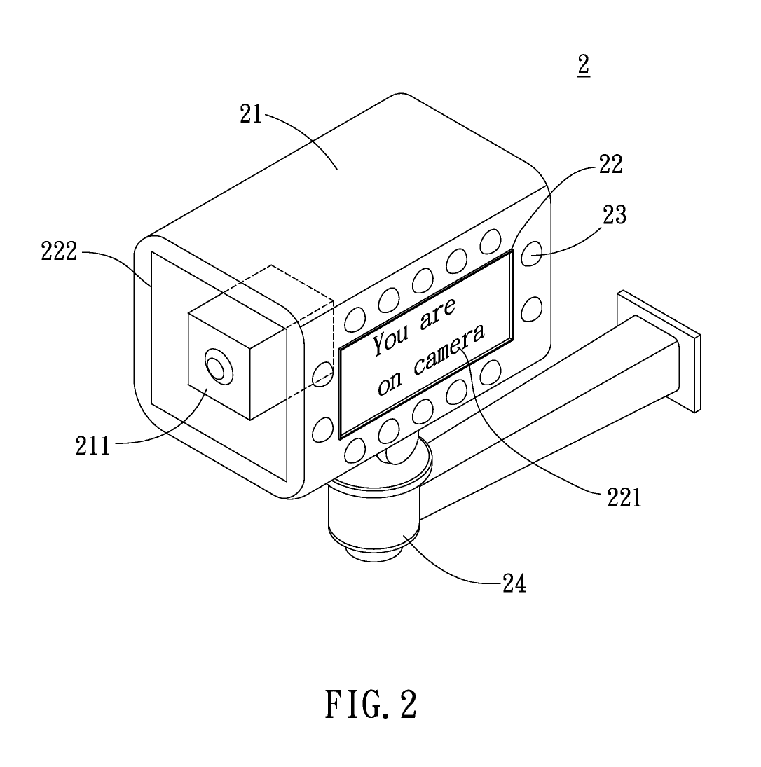

With reference to FIG. 2, FIG. 2 is the surveillance device with a display module and light-emitting modules of the second embodiment provided by the present invention, which is used in a standard type photographic device 2, including: a cover body 21, a display module 22, a plurality of light-emitting modules 23 and the mount stand 24. The cover body 21 is a rectangular parallelepiped, having an accommodating space therein for covering a photographic unit 211, and a window 222 set on one end of the cover body 21. The display module 22 is located on one surface of the cover body 21, wherein the display surface 221 of the display module 22 is exposed to the exterior face of the cover body 21 and the light-emitting modules 23 are set around the display modules 22 and the light-emitting part of the light-emitting modules 23 face toward the outer surface of the cover body 21. The mount stand 24 is connected to one surface of the cover body 21.

While in use, the power supply module(not shown in the figure) of the spherical photographic device 2 provides a current to the display module 22 and the light-emitting module 23 respectively, so each one of them can operate individually. The types of the display module 22 are divided into: a liquid crystal display (LCD), a light-emitting diode (LED) display or an organic light-emitting diode (OLED) display. Alarm function can be reached via the text messages generated by display surface 221. The light-emitting modules 23 located around the ring surface of the cover body 11 can reach highlighting purpose via full light or flashing.

Furthermore, the text messages input from an external input module (not shown in the figure) are remotely transmitted to the display module 22 for display. Or the standard type photographic device 2 can be set a memory circuit substrate (not shown in the figure) to store the text messages in advance and to electrically connect to the display module 22, so that the display module 22 is able to display the text messages.

Further, since the above mentioned photographic device 1 and the standard type photographic device 2 are out of order, it may cause the display module 12, 22 and the light-emitting module 13 and 23 not work, which can be used to judge whether the spherical photographic device 1 and the standard photographic device 2 are out of order, therefore it is noted that the failure detection is much easy and convenient.

In summary, the surveillance device with display and light-emitting of the present invention has the display module 12, 22 and the light-emitting module 13, 23 respectively set on the cover body 11, 21, which has the advantages of messages transmitting and warning improving and easy detection.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A surveillance device with a display module and light-emitting modules, comprising:
a cover body having an accommodating space;
a display module located on the cover body; and
a plurality of light-emitting modules located on the cover body,
wherein the accommodating space is for a camera, the display module is for message displaying and the light emitting module is for warning.

2. The surveillance device as recited in claim 1, wherein the surveillance device is one shape of spherical and rectangular.

3. The surveillance device as recited in claim 1, wherein the cover body is a hemispherical transparent body.

4. The surveillance device as recited in claim 1, wherein the cover body is cuboids.

5. The surveillance device as recited in claim 1, further comprising a power supply module providing current to the display module and the light-emitting modules.

6. The surveillance device as recited in claim 1, wherein the cover body covers a photographic unit.
